(19) United States
(12) Patent Application Publication
(10) Pub. No.: US 2013/0007895 A1
(43) Pub. Date: Jan. 3, 2013

(54) MANAGING ACCESS CONTROL FOR A SCREEN SHARING SESSION

(75) Inventors: Sarah N. Brolley, Raleigh, NC (US); Bernadette A. Carter, Raleigh, NC (US); Jessica W. Forrester, Raleigh, NC (US); Kathryn J. Lemanski, Raleigh, NC (US)

(73) Assignee: INTERNATIONAL BUSINESS MACHINES CORPORATION, Armonk, NY (US)

(21) Appl. No.: 13/171,802

(22) Filed: Jun. 29, 2011

(51) Int. Cl. G06F 15/16; G06F 21/00

(52) U.S. Cl. 726/28

(57) ABSTRACT

A method, system or computer usable program product for filtering content in a screen sharing session based on user access rights including initiating the screen sharing session between a first and nth user, displaying the content on a first screen of the first user wherein the content is derived from a content source including a content representation and including a set of secure elements requiring access rights to view, determining a first subset of secure elements that the nth user has access rights to view, and transmitting the content representation and the first subset of secure elements to the nth user during the screen sharing session.

### BACKGROUND

1. Technical Field

The present invention relates generally to managing access control for a screen sharing session, and in particular, to a computer implemented method for managing access control for a screen sharing session based on user access rights.

2. Description of Related Art

Screen sharing across a network is a common application and is often combined with a teleconference or other type of verbal and/or visual communication session between multiple users. This allows a presenter to share content displayed in his or her computer screen with other participants or attendees. That content may include a spreadsheet, document, presentation material, web page, a cursor for pointing, or other content the presenter may display on his or her computer screen.

The rendered content displayed on the presenter's computer screen is then compressed and possibly encrypted for transmission across a network such as the internet to the computers of the attendees. The attendees' computers then decompresses, decrypts and displays that same content on a computer screen for that attendee to view. As a result, the attendees are viewing the same information as the presenter, thereby allowing the presenter to discuss that content with the attendees in the communication session.

The presenter is also able to modify the content displayed on his or her screen, such as by scrolling through a document within a window, and the resulting rendered changes are then transmitted across the network to the attendees to view the same changes in content. This allows a presenter to transmit and control what is viewed by the attendees. This also allows the presenter to further discuss what is being displayed with the attendees in the communication session.

The presenter may share the entire content of the presenter's computer screen, which may include windows displaying content from multiple applications. As an alternative, the presenter may share the content of a single window rendered on the presenter's computer screen. In either case, it is the rendered content on the presenter's screen that is shared with the attendees during the communication session, thereby allowing the presenter to manage the information being shared.

### SUMMARY

The illustrative embodiments provide a method, system, and computer usable program product for filtering content in a screen sharing session based on user access rights including initiating the screen sharing session between a first and nth user, displaying the content on a first screen of the first user wherein the content is derived from a content source including a content representation and including a set of secure elements requiring access rights to view, determining a first subset of secure elements that the nth user has access rights to view, and transmitting the content representation and the first subset of secure elements to the nth user during the screen sharing session.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 depicts a block diagram of a network of data processing systems in which various embodiments may be implemented;

FIG. 2 depicts a block diagram of a data processing system in which various embodiments may be implemented;

FIG. 3 depicts a diagram of information which may be displayed on a presenter's computer screen in which various embodiments may be implemented;

FIG. 4 depicts a diagram of information from FIG. 3 which may be displayed on an attendee's computer screen in which various embodiments may be implemented;

FIG. 5 depicts a block diagram of multiple computer systems sharing a presentation in accordance with a first embodiment;

FIG. 6 depicts a flowchart of the operation of the screen share applications in which a first embodiment may be implemented;

FIG. 7 depicts a block diagram of multiple computer systems in a client server environment sharing a presentation in accordance with a second embodiment; and

FIG. 8 depicts a flowchart of the operation of the screen share applications in which a second embodiment may be implemented.

### DETAILED DESCRIPTION

Steps may be taken to selectively prevent the display or presentation of certain rendered information on a presenter's screen. These steps may be taken as will be explained with reference to the various embodiments below.

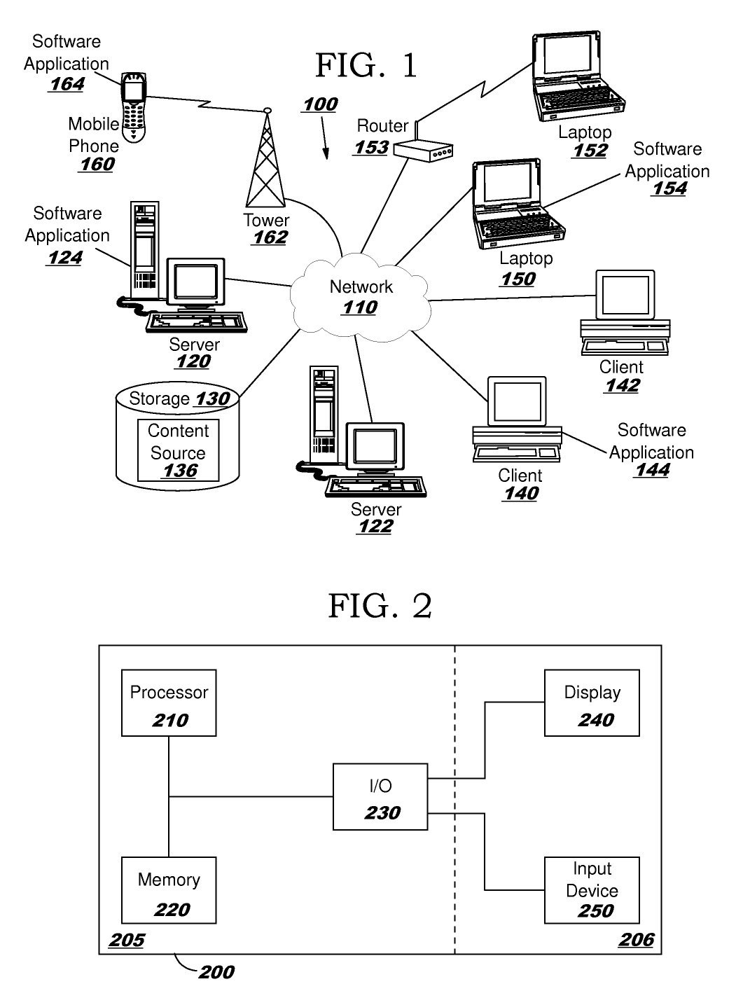

FIG. 1 depicts a pictorial representation of a network of data processing systems in which various embodiments may be implemented. Data processing environment 100 is a network of data processing systems also known as computers or computer devices in which the embodiments may be implemented. Software applications may execute on a computer or other type of data processing system in data processing environment 100. Data processing environment 100 includes network 110. Network 110 is the medium used to provide communications links between various devices and computers connected together within data processing environment 100. Network 110 may include connections such as wire, wireless communication links, or fiber optic cables.

Servers 120 and 122 and clients 140 and 142 are coupled to network 110 along with storage unit 130. In addition, laptops 150 and 152 are coupled to network 110 wirelessly through a network router 153. A mobile phone 160 is also coupled to network 110 through a mobile phone tower 162. Data processing systems, such as server 120 and 122, client 140 and 142, laptops 150 and 152, and mobile phone 160, may contain data and may have software applications including software tools executing thereon. Other types of data processing systems such as personal digital assistants (PDAs), smartphones, tablets and netbooks may be coupled to network 110.

Server 120 may include software application 124 for managing screen share security for the various computer devices or software applications in accordance with embodiments described herein. Storage 130 may contain a content source such as a spreadsheet, document, presentation, web page (or content from a web server) or other content for sharing among various computer or other data processing devices. Client 140 may include software application 144. Laptop 150 and mobile phone 160 may also include software applications 154 and 164. Other types of data processing systems coupled to network 110 may also include software applications and screen share applications as well as other security utilities. Software applications could include a web browser, email, or other software application that can process a web page, email, or other type of information to be processed.

Servers 120 and 122, storage unit 130, clients 140 and 142, laptops 150 and 152, and mobile phone 160 and other data processing devices may couple to network 102 using wired connections, wireless communication protocols, or other suitable data connectivity. Clients 140 and 142 may be, for example, personal computers or network computers.

In the depicted example, server 120 may provide data, such as boot files, operating system images, and applications to clients 140 and 142 and laptop 150. Clients 140 and 142 and laptop 150 may be clients to server 120 in this example. Clients 140 and 142, laptops 150 and 152, mobile phone 160, or some combination thereof, may include their own data, boot files, operating system images, and applications. Data processing environment 100 may include additional servers, clients, and other devices that are not shown.

In the depicted example, data processing environment 100 may be the Internet. Network 110 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

FIG. 2 depicts a block diagram of a data processing system in which various embodiments may be implemented. Data processing system 200 is an example of a computer device, such as server 120, client 140, laptop 150 or mobile phone 160 in FIG. 1, in which computer usable program code or instructions implementing the processes may be located for the illustrative embodiments.

In the depicted example, data processing system 200 includes a CPU or central processing unit 210 which may contain one or more processors and may be implemented using one or more heterogeneous processor systems including a graphics processor. The depicted example also includes a memory 220 which may be used for storing instructions and data to be processed by CPU 210. Memory 220 may include a main memory composed of random access memory (RAM), read only memory (ROM), or other types of storage devices. Memory 210 could also include secondary storage devices such as a hard disk drive, DVD drive or other devices which may be internal or external to data processing system 200. An input output device (I/O) 230 is also shown in the depicted example for managing communications with various input devices and output devices. However, other examples could use the CPU to communicate directly with various input or output devices or use separate input and output controllers.

In the depicted example, a computer display 240 is shown for the data processing system to communicate with a user or another data processing system. Other types of output devices may be used such as an audio device. An input device 250 is also shown which may be a keyboard, mouse, a touch sensitive display, or other types of input devices.

Data processing system 200 is shown with an internal section 205 and an external section 206. Often input and output devices may be physically separate from but connected to the CPU and memory. However, that is often not the case with portable devices such as mobile phones.

An operating system may run on processor 210. The operating system coordinates and provides control of various components within data processing system 200 in FIG. 2. The operating system may be a commercially available operating system. An object oriented programming system may run in conjunction with the operating system and provides calls to the operating system from programs or applications executing on data processing system 200. Instructions for the operating system, the object-oriented programming system, and applications or programs may be located on secondary storage devices such a hard drive, and may be loaded into RAM for execution by processing unit 210.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1 and 2. In addition, the processes of the embodiments may be applied to a multiprocessor data processing system.

The depicted examples in FIGS. 1-2 and above-described examples are not meant to imply architectural limitations. For example, data processing system 200 may also be a mobile phone 160, tablet computer, laptop computer, or telephone device.

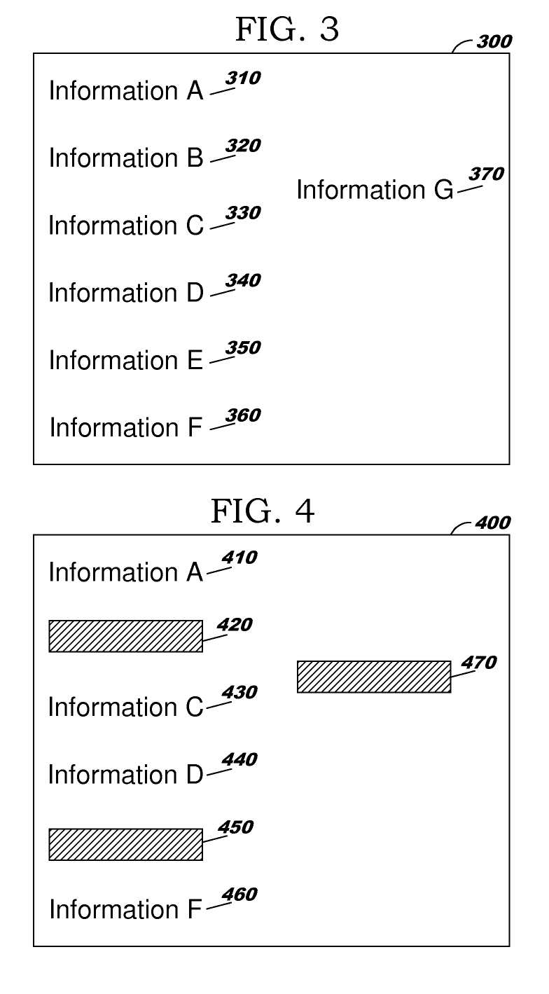

FIG. 3 depicts a diagram of information which may be displayed on a presenter's computer screen in which various embodiments may be implemented. A screen or window 300 is shown displaying information which may be generated by one or more applications from one or more content sources such as a spreadsheet, document, database, web page (or content from a web server) or other type of content. Seven elements of information are shown as Information A 310, Information B 320, Information C 330, Information D 340, Information E 350, Information F 360 and Information G 370. These elements of information may be cells of a spreadsheet, paragraphs of a document, parts of a presentation, parts of a web page, etc. These elements may also be grouped in multiple windows shown on a screen. For example, Information A through F may be information in a first window from a first application such as a spreadsheet and Information G may be information in a second window from a second application such as a document.

Certain information, referred to as secure elements in a content source, may be identified as sensitive, confidential, secure, or otherwise undesirable to display freely, such as in a screen sharing session. Those secure elements may be highlighted or otherwise indicated as such by an owner or other authorized person or entity. The owner may be the presenter or may be another person or entity managing that content source. For example, an owner may be the creator of a document that is later presented by a different person in a screen sharing session. In such a case, the owner may identify secure elements that may not be viewable by the presenter. The areas not visible to the presenter may be highlighted or otherwise marked on the screen of an attendee with access to those secure elements to indicate to the attendee that the content of that area is not visible to the presenter. Once secure elements are highlighted or otherwise indicated, additional data may be specified such as the security level of that information. These security settings may be stored as security metadata linked to the content source.

In this example, Information B 320, Information E 350 and Information G 370 may be indicated as secure elements and displayed to users with the necessary authorization or permissions referred to herein as access rights. As a result, security metadata is generated indicating such.

FIG. 4 depicts a diagram of information from FIG. 3 which may be displayed on an attendee's computer screen in which various embodiments may be implemented. If the attendee does not have the necessary access rights, then the elements marked as secure may not be displayed on the attendee's computer screen 400. Access rights can be based on the identity of a user, the location of an user's system relative to a firewall, the job position of the user within a company (e.g. director level and above), or other identifying characteristics which may be selected. Information A 410, Information C 430, Information D 440 and Information F 460 are displayed on the attendee's computer screen. However, Information B, Information E and Information G may not be displayed on an attendee's computer screen because they were marked as secure. Instead, a blacked out, blurred, obscured, or otherwise redacted image is provided as boxes 420, 450 and 470. In an alternative embodiment, alternative less sensitive content may be provided for display in the redacted areas.

A second attendee may have the necessary access rights to view all information from the content source or sources and may view the same secure elements as shown in FIG. 3. A third attendee may have the necessary access rights to view some of the secure elements from the secure source such as Information G 370. As a result, Information G may be displayed on the third attendee's computer screen, but not Information B or Information E. Another possibility is that the presenter may not have the necessary access rights to view all the elements in the content source. As a result, the presenter may actually view less information than certain attendees.

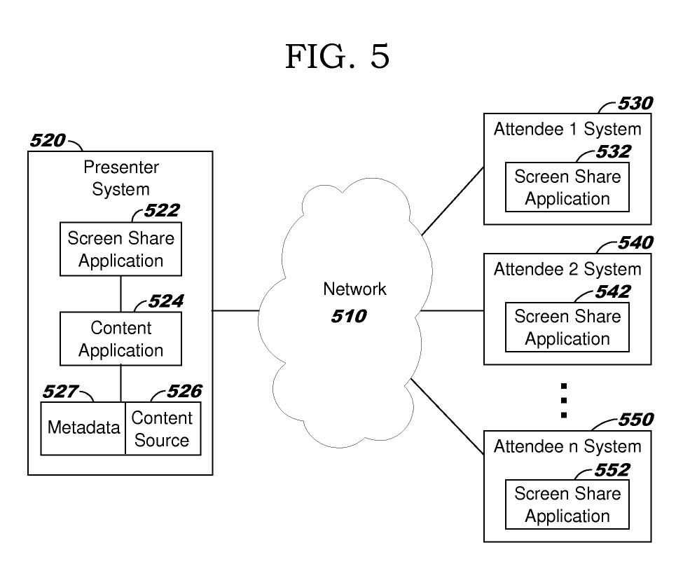

FIG. 5 depicts a block diagram of multiple computer systems sharing a presentation in accordance with a first embodiment. A network 510 is utilized to interconnect several computer systems. The network may be the internet but could be a type of network where computer screen information may be shared.

A presenter system 520 is shown interconnected across the network with multiple attendee systems 530, 540 and 550. Additional attendee systems may be interconnected as well. Each system may be a data processing system and may be a computer, a cell phone, or other type of data processing system. Presenter system 520 may include a screen share application 522, a content application 524 and a content source 526 with metadata 527 specifying which elements of the content source are secure and the level of that security. Metadata 527 may also include additional information such as the location of the secure elements, an application program interface (API) to the content source, or even the secure information stored in a secure manner inaccessible without a password or key. The content source may be a document, spreadsheet, database, web page or other type of information which may be rendered in a presenter's computer screen by a content application 524. The content source may also be a set of documents including spreadsheets, databases, etc. which may be managed by multiple applications. As will be further described below, the content source may be a proprietary form of data accessible by certain content applications. The content source may also be a standard or commonly known form of data such as HTML or a scripting, declarative or interpreted language broadly accessible by a variety of content applications such as a web browser.

Screen share application 522 is utilized to share the screen contents of the presenter's system with the various attendee systems. Attendee 1 system 530, attendee 2 system 540 and attendee n system 550 include a screen share application 532, 542 and 552 respectively. The attendees' screen share applications may not need all the functionality of the presenter screen share application 522. That is, the attendee screen share applications may only contain the logic to display information from the presenter's screen share application in accordance with the first embodiment. The attendee screen share applications may be downloaded onto the attendee systems as the screen sharing process is initiated.

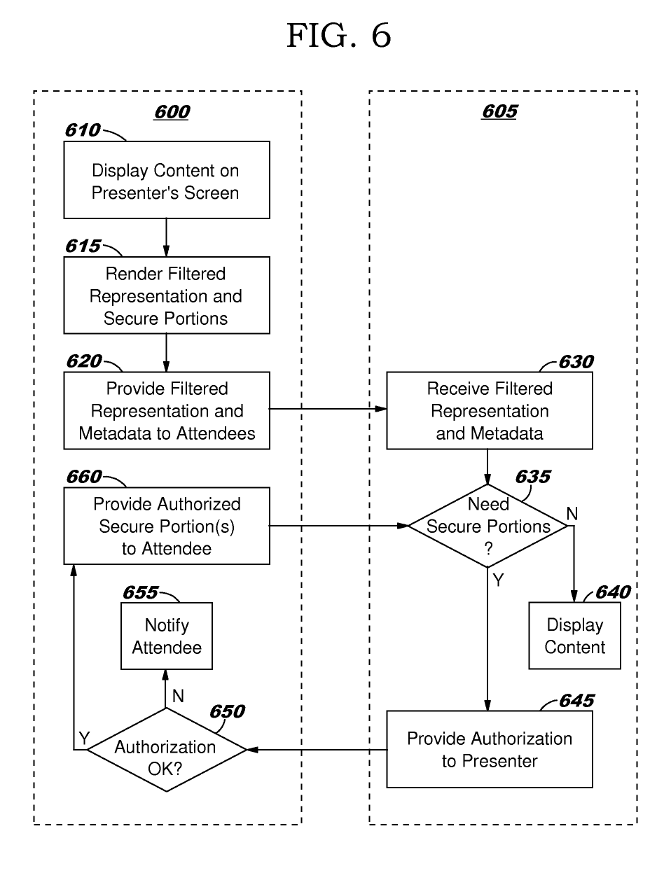

FIG. 6 depicts a flowchart of the operation of the screen share applications in which a first embodiment may be implemented. The steps of the flowchart performed by the presenter's screen share application and content application on the presenter's data processing system are shown in dashed outline 600, the steps performed by the attendee screen share applications on the attendee's data processing system are shown in dashed box 605.

In a first step 610, the content application renders the content source onto the presenter's screen. In a second step 615, the presenter's screen share application, in conjunction with the content application, renders a representation of filtered information from the content source and metadata as well as separately rendering secure elements of the content source. The filtered content representation may not include information indicated as secure by the metadata. The information indicated as secure by the metadata is in the secure elements. The content representation and secure elements may be rendered as bitmaps, although other forms of data representation may be utilized, particularly if the content source is in HTML or a scripting, declarative or interpreted language.

In an alternative embodiment, the filtered representation and secure elements may be rendered or otherwise generated before display on the presenter's screen and are then provided for display together on the presenter's computer display screen based on the access rights of the presenter and the security levels indicated by the metadata. In such an alternative embodiment, elements of the representation that are secure and not authorized to be viewed by the presenter may be blacked out, blurred, obscured or otherwise redacted including substituting different content.

In a third step 620, the presenter's screen share application then provides the filtered representation with the metadata to the attendee screen share applications. This representation may not include secure elements of the content source as indicated by the metadata, although in an alternative embodiment the secure elements may be encrypted and included as part of the metadata such that it is accessible if a user has a password or key.

In step 630, the attendee screen share applications receive the filtered representation and metadata from the presenter's screen share application. In step 635, the attendee's screen share application determines from the metadata whether there are secure elements that have not been provided. If not, then in step 640 the filtered representation is rendered onto the attendee's display screen including secure elements provided as described below. Secure elements not included may be filled in with a preset fill such as a blacked out area. If yes in step 635, then in step 645 the access rights of the attendee may be sent through the presenter's screen share application to the presenter's content application and content source. If the content source is not a proprietary form of data or if the secure elements have already been rendered, then the content application may not be needed to process the attendee request. That may be managed by the presenter's screen share application and or the content source instead.

In step 650 and in response to step 645 above, the presenter's content application and content source verify whether the attendee has the necessary access rights to view the requested secure information as required in the metadata. If not, then in step 655 notice is sent through the presenter's screen share application to the attendee's screen share application and processing is returned to step 635. If yes, then the authorized secure information is provided through the presenter's screen share application to the attendee's screen share application and processing returns to step 635.

In this embodiment, each section of secure information is requested separately by the attendee's screen share application. In an alternative embodiment, the request may be performed as a single step with all secure information requested at one time. In another alternative embodiment, the presenter's screen share application may obtain each attendee's security level as each attendee is linked to the screen share session. In this alternative embodiment, the presenter's screen share application may provide separately rendered representations for each attendee or for each class of attendees based on their security level. In a further alternative embodiment, the metadata may include the level of authorization or access rights needed for each element of secure data so that the attendee's screen share application requests the secure data that it is authorized to receive.

Although the above was described with reference to a single application, it could also be applied to multiple applications and multiple content sources displayed on a presenter's screen. A single content representation may be generated for display with content from each content source. Secure elements from each content source may also be identified for display, with each user viewing those secure elements where the user has the necessary access rights.

The steps of FIG. 6 may be implemented each time the presenter modifies or changes the content displayed and shared with the attendees. For example, if the presenter scrolls through a displayed document, then different portions of the document will be displayed. As a result, the above described steps may be repeated for those portions of the document not previously displayed.

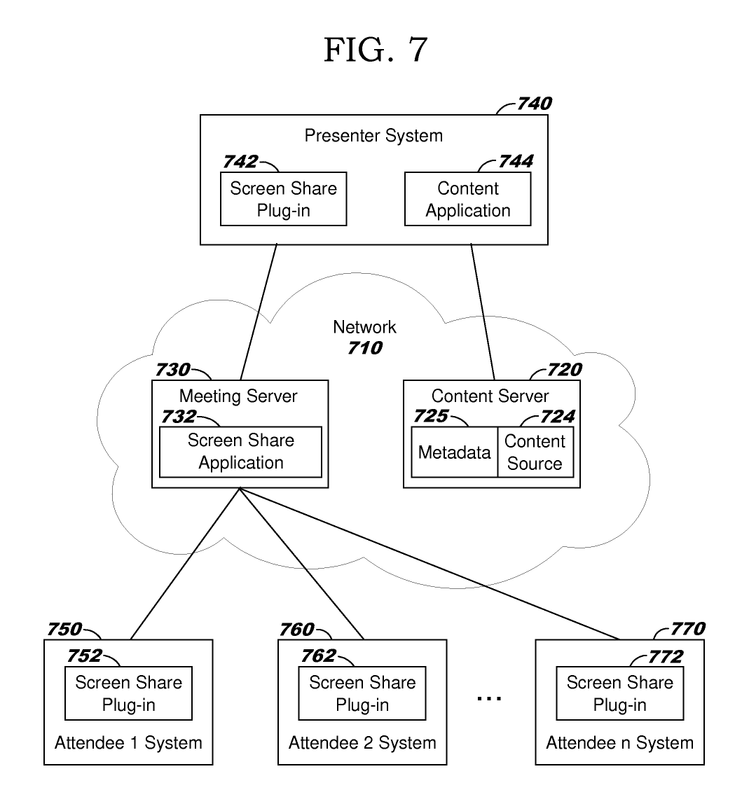

FIG. 7 depicts a block diagram of multiple computer systems in a client server environment sharing a presentation in accordance with a second embodiment. A network 710 is utilized to interconnect several computer systems. The network may be the internet but could be a type of network where computer screen information may be shared.

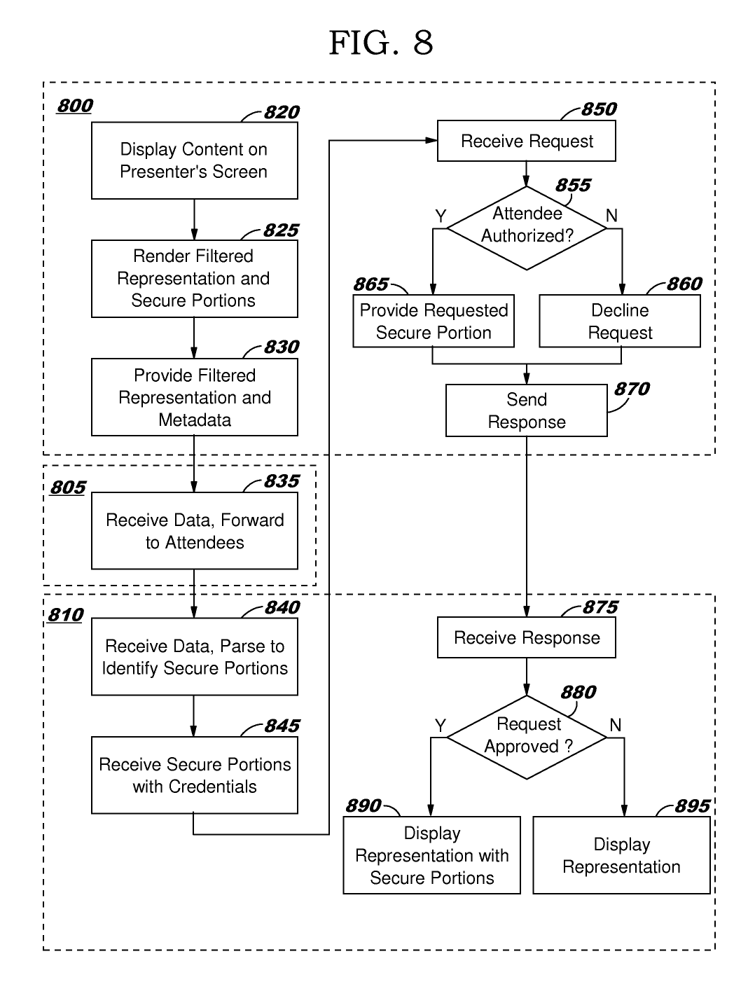

The network includes a content server 720 and a meeting server 730. Content server 720 contains a content source 724 which may be used in a presentation as described with reference to FIG. 8 below. Content source 724 may be a document, spreadsheet, database, web page or other type of information which may be rendered in a presenter's computer screen. The content source may also be a set of documents including spreadsheets, databases, etc. which may be managed by multiple applications. As will be further described below, the content source may be a proprietary form of data accessible by certain content applications. The content source may also be a standard or commonly known form of data such as HTML or a scripting, declarative or interpreted language broadly accessible by a variety of content applications such as a web browser.

Content server 720 also contains metadata 725 specifying which elements of content source 724 may be secure and the level of that security. Metadata 725 may also include additional information such as the location of the secure elements, an API to the content source, or even the secure information stored in a secure manner inaccessible without a password or key. Meeting server 730 includes a screen share application 732 for use in managing the presentation as described with reference to FIG. 8 below.

A presenter system 740 is shown interconnected across the network with multiple attendee systems 750, 760 and 770 through meeting server 730. Additional attendee systems may be interconnected as well. The systems may be data processing systems and may be a computer, a cell phone, or other type of data processing system. Presenter system 740 includes a screen share plug-in 742 and a content application 744. Content application 744 may be used to render content source on a presenter's computer screen. In an alternative embodiment, the content application may be located on content server 720 such as in a cloud environment. In another alternative embodiment, the content source and metadata may be located on the presenter system 740 whereby no content server may be needed for implementing the second embodiment.

Presenter system 740 also contains a screen share plug-in 742. The presenter's screen share plug-in may not need the same functionality of screen share application 732. The presenter's screen share plug-in may coordinate with the content application to filter all secure elements of the content source and retain those secure elements for handling all calls from attendee screen share applications. In alternative embodiments, the secure elements, either in a bitmap representation or other data representation, may be sent to the content server or the meeting server, which would handle all calls from attendee screen share applications for the secure elements.

Attendee 1 system 750, attendee 2 system 760, and attendee n system 770 include screen share applications 752, 762 and 772 respectively. The attendee screen share application may not need all the functionality of screen share application 732. That is, the attendee screen share plug-ins may only contain the logic to receive the filtered representation from the presenter's screen share application, make calls for secure elements with attendee credentials, and then display the filtered representation and authorized secure elements in accordance with the second embodiment. The attendee screen share plug-ins may be downloaded onto the attendee systems as the screen sharing process is initiated.

FIG. 8 depicts a flowchart of the operation of screen share applications in which a second embodiment may be implemented. The steps of the flowchart performed by the presenter's screen share plug-in in conjunction with the content application and the content server are shown in dashed outline 800, the steps performed by the meeting server screen share application are shown in dashed box 805 and the steps performed by the attendee screen share plug-ins are shown in dashed box 810.

In a first step 820, the content application renders data from the content source onto the presenter's screen. In a second step 825, the presenter's screen share plug-in in conjunction with the content application renders a representation of filtered information from the content source and metadata located on the content server as well as separately rendering the secure elements of the content source. The filtered content representation may not include information indicated as secure by the metadata. The information indicated as secure by the metadata is in the secure elements. The content representation and secure elements may be rendered as bitmaps, although other forms of data representation may by utilized, particularly if the content source is in HTML or a scripting, declarative or interpreted language.

In an alternative embodiment, the filtered representation and secure elements may be rendered or otherwise generated before display on the presenter's screen and then are displayed together on the presenter's computer display screen based on the access rights of the presenter and the security levels indicated by the metadata. In such an alternative embodiment, elements of the representation that are secure and not authorized to be viewed by the presenter may be blacked out, blurred, obscured or otherwise redacted, including substituting different content.

In a third step 830, the presenter's screen share plug-in then provides the filtered representation with the metadata to the meeting server screen share application. This content representation may not include secure elements of the content source as indicated by the metadata. In an alternative embodiment, the presenter's screen share application may also provide the secure elements to the meeting server for the meeting server to manage the calls for those secure elements from the attendee screen share plug-ins.

In step 835, the meeting server screen share application provides the filtered representation and metadata to the attendee screen share plug-ins. The attendee plug-ins then receive the data in step 840 and parse that data to determine what sections are secure. In step 845, a secure element is requested with the credentials of the attendee. In this embodiment, each secure element may be requested separately by the attendees. In an alternative embodiment, each attendee may request all secure elements in a single request. The request may be sent to the content application located on the presenter's system to manage the request. In alternative embodiments, the content server or the meeting server may receive and manage the requests for secure elements.

In step 850, the content application receives the request. In step 855, it is determined whether the attendee is authorized to view the requested secure element as was specified in the metadata. If not, then in step 860, the request is declined. If yes, then in step 865 the requested secure element is provided to the attendee. In step 870, the results of steps 860 or 865 are sent to the requesting attendee's screen share plug-in.

In step 875, the response is received by the attendee's screen share plug-in. In step 880, the plug-in determines whether the requested secure element was provided. If not, then in step 885 the representation is displayed without the secure element and the element of the representation not authorized to be viewed by the attendee may be blacked out, blurred, obscured or otherwise redacted including substituting different content. If yes, then in step 890, the attendee's screen share plug-in displays a combination of the filtered representation with authorized secure elements for the attendee to view.

As described above, steps 845 through 875 may be repeated for each secure element of the representation, possibly in parallel. In an alternative embodiment, attendees may request all secure elements in a single request. In another alternative embodiment, the meeting server screen share application may obtain each attendee's security level as each attendee is linked to the screen share session. In this alternative embodiment, separately rendered representations may be provided for each attendee or for each class of attendees based on their security level. In a further alternative embodiment, the metadata may include the level of access rights needed for each element of secure data so that the attendee's screen share application requests the secure data that it is authorized to receive.

Other embodiments may include metadata regarding credentials needed for a presenter or a meeting server. That is, a person may not be able to present a certain content source unless the presenter and the meeting server are authorized to do so. In addition, the presenter may have the authority to override certain security requirements so long as the presenter has the necessary credentials.

Although the above was described with reference to a single application, it could also be applied to multiple applications and multiple content sources displayed on a presenter's screen. A single content representation may be generated for display with content from each content source. Secure elements from each content source may also be identified for display, with users viewing those secure elements where the users have the necessary access rights.

The steps of FIG. 8 may be implemented each time the presenter modifies or changes the content displayed and shared with the attendees. For example, if the presenter scrolls through a displayed document, then different portions of the document will be displayed. As a result, the above described steps may be repeated for those portions of the document not previously displayed.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

A combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or a suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or a suitable combination of the foregoing. In the context of this document, a computer readable storage medium may be a tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms, including, but not limited to, electro-magnetic, optical, or a suitable combination thereof. A computer readable signal medium may be a computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or a suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code may include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as screen sharing applications or plug-ins. A client data processing system may download that computer usable code, such as for storing on a data storage medium associated with the client data processing system, or for using in the client data processing system. The server data processing system may similarly upload computer usable code from the client data processing system such as a content source and metadata. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of filtering content in a screen sharing session based on user access rights comprising:
initiating the screen sharing session between a first and second user;
displaying the content on a first screen of the first user wherein the content is derived from a content source including a content representation and including a set of secure elements requiring access rights to view;
determining a first subset of secure elements that the second user has access rights to view; and
transmitting the content representation and the first subset of secure elements to the second user during the screen sharing session.

2. The method of claim 1 wherein the first user has full access rights to the set of secure elements.

3. The method of claim 1 wherein the first user has limited access rights further comprising determining a second subset of secure elements that the first user has access rights to view wherein the second subset is not equal to the set and wherein the difference is displayed as a redacted area on the first screen.

4. The method of claim 1 wherein secure elements of the set not in the first subset are redacted with spatially equivalent content for display on a second screen for the second user.

5. The method of claim 1 further comprising:
initiating the screen sharing session between the first user and a third user;
determining a third subset of secure elements that the third user has access rights to view wherein the third subset is not equal to the first subset; and
transmitting the content representation and the third subset of secure elements to the third user during the screen sharing session.

6. The method of claim 5 wherein the content includes a document from a fourth user that established the access rights of the second and third users to a set of document secure elements, the method further comprising:
determining a first subset of document secure elements that the second user has access rights to view and a second subset of document secure elements that the third user has access rights to view wherein the first and second subsets of document secure elements are not equal; and
transmitting the first subset of document secure elements to the second user and the second subset of document secure elements to the third user during the screen sharing session.

7. The method of claim 1 wherein the content source includes a plurality of documents managed by a plurality of applications.

8. The method of claim 6 wherein the first user has limited access rights further comprising determining a second subset of secure elements that the first user has access rights to view wherein secure elements of the set not in the second subset are redacted with spatially equivalent content for display on a first screen for the first user.

9. A computer usable program product comprising a computer usable storage medium including computer usable code for use in filtering content in a screen sharing session based on user access rights, the computer usable program product comprising code for performing the steps of:
initiating the screen sharing session between a first and second user;
displaying the content on a first screen of the first user wherein the content is derived from a content source including a content representation and including a set of secure elements requiring access rights to view;
determining a first subset of secure elements that the second user has access rights to view; and
transmitting the content representation and the first subset of secure elements to the second user during the screen sharing session.

10. The computer usable program product of claim 9 wherein the first user has full access rights to the set of secure elements.

11. The computer usable program product of claim 9 wherein the first user has limited access rights further comprising the step of determining a second subset of secure elements that the first user has access rights to view wherein the second subset is not equal to the set and wherein the difference is displayed as a redacted area on the first screen.

12. The computer usable program product of claim 9 wherein secure elements of the set not in the first subset are redacted with spatially equivalent content for display on a second screen for the second user.

13. The computer usable program product of claim 9 further comprising code for performing the steps of:
initiating the screen sharing session between the first user and a third user;
determining a third subset of secure elements that the third user has access rights to view wherein the third subset is not equal to the first subset; and
transmitting the content representation and the third subset of secure elements to the third user during the screen sharing session.

14. The computer usable program product of claim 13 wherein the content includes a document from a fourth user that established the access rights of the second and third users to a set of document secure elements, the computer usable program product further comprising code for performing the steps of:
determining a first subset of document secure elements that the second user has access rights to view and a second subset of document secure elements that the third user has access rights to view wherein the first and second subsets of document secure elements are not equal; and
transmitting the first subset of document secure elements to the second user and the second subset of document secure elements to the third user during the screen sharing session.

15. The computer usable program product of claim 9, wherein the product is stored in a computer readable storage medium in a data processing system, and wherein the instructions were downloaded over a network from a remote data processing system.

16. The computer usable program product of claim 9, wherein the product is stored in a computer readable storage medium in a server data processing system, and wherein the instructions are downloaded over a network to a remote data processing system for use in a computer readable storage medium with the remote system.

17. A data processing system for filtering content in a screen sharing session based on user access rights, the data processing system comprising:
a processor; and
a memory storing program instructions which when executed by the processor execute the steps of:
initiating the screen sharing session between a first and second user;
displaying the content on a first screen of the first user wherein the content is derived from a content source including a content representation and including a set of secure elements requiring access rights to view;
determining a first subset of secure elements that the second user has access rights to view; and
transmitting the content representation and the first subset of secure elements to the second user during the screen sharing session.

18. The data processing system of claim 15 wherein the first user has limited access rights and wherein the system further executes the step of determining a second subset of secure elements that the first user has access rights to view wherein the second subset is not equal to the set and wherein the difference is displayed as a redacted area on the first screen.

19. The data processing system of claim 17 wherein the system executes the further steps of:
initiating the screen sharing session between the first user and a third user;
determining a third subset of secure elements that the third user has access rights to view wherein the third subset is not equal to the first subset; and
transmitting the content representation and the third subset of secure elements to the third user during the screen sharing session.

20. The data processing system of claim 19 wherein the content includes a document from a fourth user that established the access rights of the second and third users to a set of document secure elements, wherein the system executes the further steps of:
determining a first subset of document secure elements that the second user has access rights to view and a second subset of document secure elements that the third user has access rights to view wherein the first and second subsets of document secure elements are not equal; and
transmitting the first subset of document secure elements to the second user and the second subset of document secure elements to the third user during the screen sharing session.
